(19) United States
(12) Patent Application Publication
(10) Pub. No.: US 2011/0074797 A1
(43) Pub. Date: Mar. 31, 2011

(54) DISPLAY TERMINAL DEVICE, IMAGE DISPLAY CONTROL METHOD, AND STORAGE MEDIUM

(75) Inventor: Etsuteru Inoue, Obu-shi (JP)

(73) Assignee: BROTHER KOGYO KABUSHIKI KAISHA, Nagoya-shi (JP)

(21) Appl. No.: 12/889,870

(22) Filed: Sep. 24, 2010

(30) Foreign Application Priority Data
Sep. 30, 2009 (JP) 2009-227704

(51) Int. Cl. G06T 1/00

(52) U.S. Cl. 345/522

(57) ABSTRACT

A display terminal device is provided. The device includes a display unit including a display area for displaying image information, a display control unit configured to control the display unit to display a plurality of image information by switching the image information, an image information acquiring unit configured to acquire display information to be displayed while being added to the image information and acquire the image information which is associated with a plurality of display information, a display condition control unit configured to control a reproduction display condition, under which while image information is displayed on the display unit, a plurality of display information associated with the image information are consecutively reproduced and displayed, and control a switching condition, under which one of the image information is switched into another of the image information, based on the plurality of display information acquired by the image information acquiring unit.

### CROSS-REFERENCE TO RELATED APPLICATION

This application claims priority from Japanese Patent Application No. 2009-227704, filed on Sep. 30, 2009, the entire subject matter of which is incorporated herein by reference.

### TECHNICAL FIELD

Aspects of the present invention relate to a display terminal device which displays image information associated with a plurality of display information, an image display control method, and a storage medium.

### BACKGROUND

It is known a digital photo frame which displays an image on a display unit by reading the image stored in a certain storage medium. Further, it is know a digital photo frame or a general display unit which can perform display control for a slideshow of displaying a plurality of images by intermittently switching the images in a certain time period. In addition, it is known a reproduction device which can perform display control for the slideshow by varying play speed and play time under preset conditions such that reproduction of the slideshow does not become monotonous or boring.

However, in the reproduction device, it is necessary to set the play speed or the play time in advance, and such setting operation is complicated. In addition, if a plurality of manual input information, such as a comment, are added to an image by a plurality of users using a device having a hand input device, such as a touch panel, there is a desire to perform control for displaying the image by a slideshow under conditions suitable for input conditions of the manual input information. However, currently, a technique for realizing this desire has not been provided.

### SUMMARY

Accordingly, it is an aspect of the present invention to provide a display terminal device which can switch a plurality of image information and display information, which is a plurality of input information added to the image information, according to a switching time suitable for an input condition of the display information when reproducing and displaying the display information on the same display screen as of the image information, which is being displayed.

According to an illustrative embodiment of the present invention, there is provided a display terminal device comprising: a display unit including a display area for displaying image information; a display control unit configured to control the display unit to display a plurality of image information by switching the image information; an image information acquiring unit configured to acquire display information to be displayed while being added to the image information and acquire the image information which is associated with a plurality of display information; and a display condition control unit configured to control a reproduction display condition, under which while image information is displayed on the display unit, a plurality of display information associated with the image information are consecutively reproduced and displayed, and control a switching condition, under which one of the image information is switched into another of the image information, based on the plurality of display information acquired by the image information acquiring unit.

According to another illustrative embodiment of the present invention, there is provided a method for controlling a display terminal device including a display area for displaying image information and a display control unit configured to control the display unit to display a plurality of image information by switching the image information. The method comprises: acquiring display information to be displayed while being added to the image information and acquiring the image information which is associated with a plurality of display information; and based on the acquired plurality of display information, controlling a reproduction display condition, under which while image information is displayed on the display unit, a plurality of display information associated with the image information are consecutively reproduced and displayed, and controlling a switching condition, under which one of the image information is switched into another of the image information.

According to a further illustrative embodiment of the present invention, there is provided a storage medium having a computer program stored thereon and readable by a computer for a display terminal device including a display area for displaying image information and a display control unit configured to control the display unit to display a plurality of image information by switching the image information, the computer program, when executed by the computer, causing the computer to perform operations. The operations comprise: acquiring display information to be displayed while being added to the image information and acquiring the image information which is associated with a plurality of display information; and based on the acquired plurality of display information, controlling a reproduction display condition, under which while image information is displayed on the display unit, a plurality of display information associated with the image information are consecutively reproduced and displayed, and controlling a switching condition, under which one of the image information is switched into another of the image information.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a schematic configuration view of a display terminal device 10;

FIG. 2 is an electrical configuration view of the display terminal device 10;

FIG. 3 is an explanatory diagram of a flash ROM 24;

FIG. 4 is an explanatory diagram of an image information database 2411;

FIG. 5 is an explanatory diagram of a slideshow information database 2421;

FIG. 6 is an explanatory diagram of a display screen of the display terminal device 10;

FIGS. 7A and B are explanatory diagrams of a display information database 2431;

FIG. 8 is a flowchart of a main process executed by the display terminal device 10;

FIG. 9 is a flowchart of a switching time-setting process executed by the display terminal device 10;

FIG. 10 is an explanatory view of a switching time information database 2422;

FIG. 11 is an explanatory diagram of a display screen of the display terminal device 10;

FIG. 12 is an explanatory diagram of a display screen of the display terminal device 10;

FIG. 13 is a flowchart of an image transmission process executed in a first modified illustrative embodiment;

FIG. 14 is a flowchart of main process 2 executed in the first modified illustrative embodiment;

FIG. 15 is an explanatory diagram of an image information database 2412 in the first modified illustrative embodiment;

FIG. 16 is a flowchart of a process of reproducing display information executed in the first modified illustrative embodiment; and

FIG. 17 is a flowchart of a process of reproducing display information according to a second modified illustrative embodiment in step S104 of the main process shown in FIG. 8.

### DETAILED DESCRIPTION

Hereinafter, a display terminal device according to an illustrative embodiment of the present invention will be described with reference to the accompanying drawings. However, it should be appreciated that these drawings are used merely to illustrate technical features that the present invention can adopt. The configuration of the apparatus, the flowchart of each process, and the like described herein are intended to be explanatory only, so that the present invention is not limited thereto.

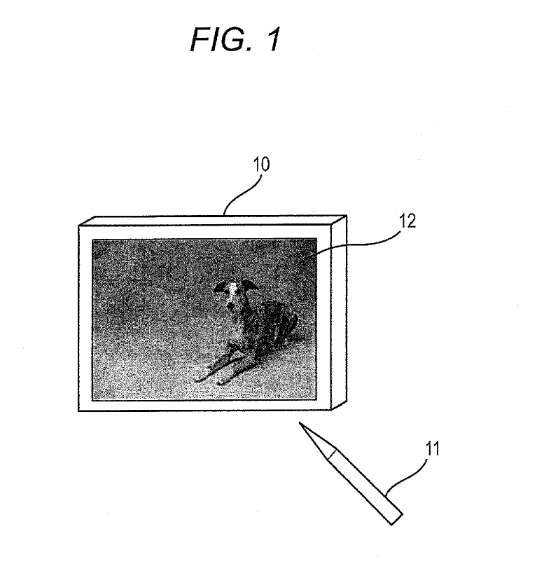

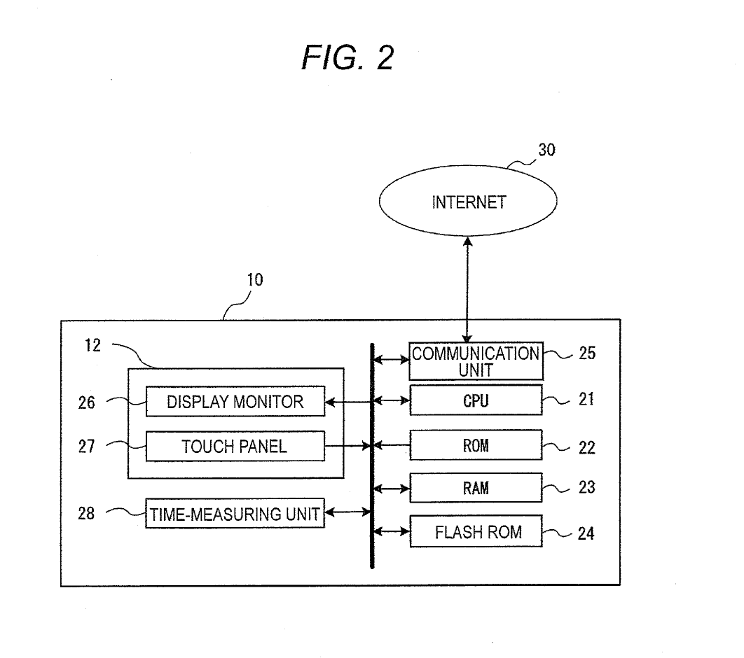

First, with reference to FIGS. 1 and 2, the outer configuration and electrical configuration of a display terminal device 10 according to an illustrative embodiment will be described.

With reference to FIG. 1, the display terminal device 10 of this illustrative embodiment will be described. As shown in FIG. 1, the display terminal device 10 includes a rectangular casing and a display unit 12 provided in the casing to display image information. A touch panel is provided to overlap the display unit 12, and acquires position information, which is input by a finger of a user or a touch pen 11 for the touch panel. The touch pen 11 is described by way of an example.

Next, with reference to FIG. 2, the electrical configuration of the display terminal device 10 will be described. As shown in FIG. 2, the display terminal device 10 of this illustrative embodiment includes a Central Processing Unit (CPU) 21, a Read Only Memory (ROM) 22, a Random Access Memory (RAM) 23, flash ROM 24, and a display monitor 26 and a touch panel 27, which configure the display unit 12, and also includes a time-measuring unit 28 and a communication unit 25. All of these components are connected to each other via bus.

The CPU 21 is configured to control the entire display terminal device 10. The ROM 22 stores a program or settings necessary for basic operations of the display terminal device 10. The CPU 21 controls the operations of the display terminal device 10 following the program stored in the ROM 22. The RAM 23 is a storage device that temporarily stores various data. The flash ROM 24 is a nonvolatile semiconductor memory that has various storage areas, which will be described later.

The display unit 12 includes an operation screen on which the user performs various operations on the display terminal device 10, a display monitor 26 that displays image data or the like acquired from other devices, and the general-use touch panel 27 that is provided to overlap the display monitor 26. When the user makes a touch input by referring to the display unit 12, the touch panel 27 can acquire position information on the touch input. The time-measuring unit 28 is a device that has a function of a watch to display the present time, and also has a function of adding present time information to the position information acquired by the touch panel. The communication unit 25 is a device that can transmit and receive image information to be displayed on the display unit 12, to and from other devices via the Internet 30. Herein, the communication unit 25 may be a device that can transmit and receive information via telephone lines.

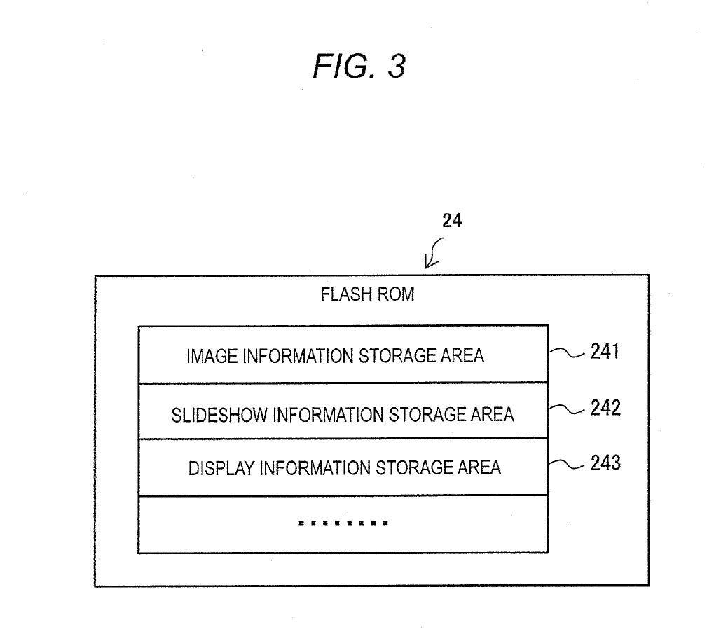

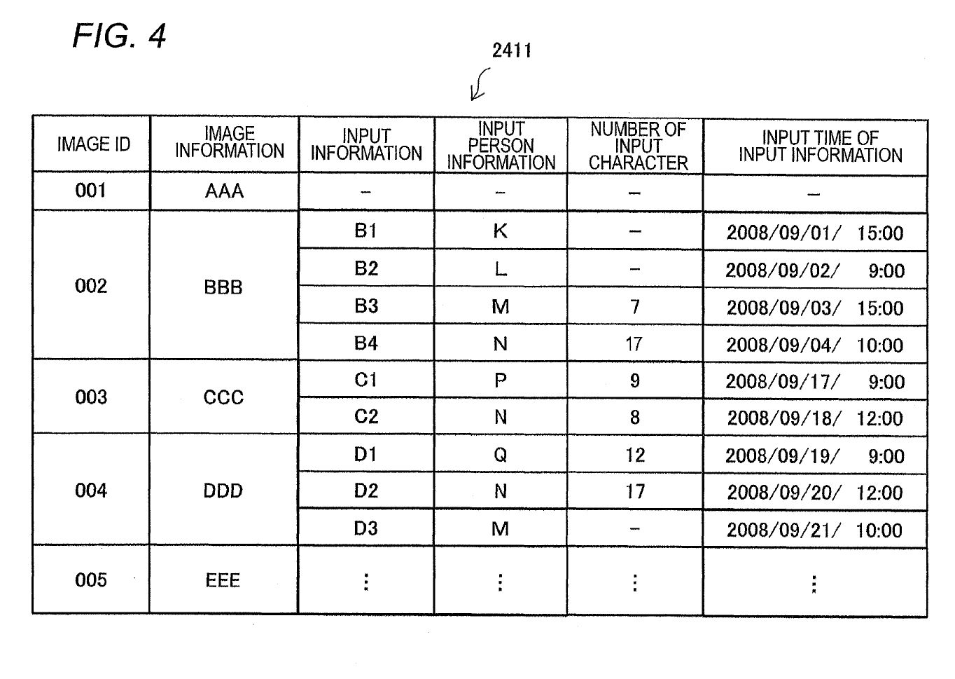

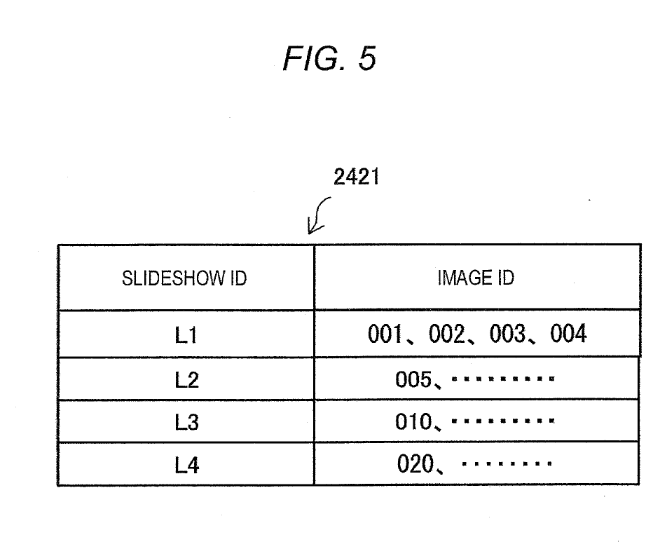

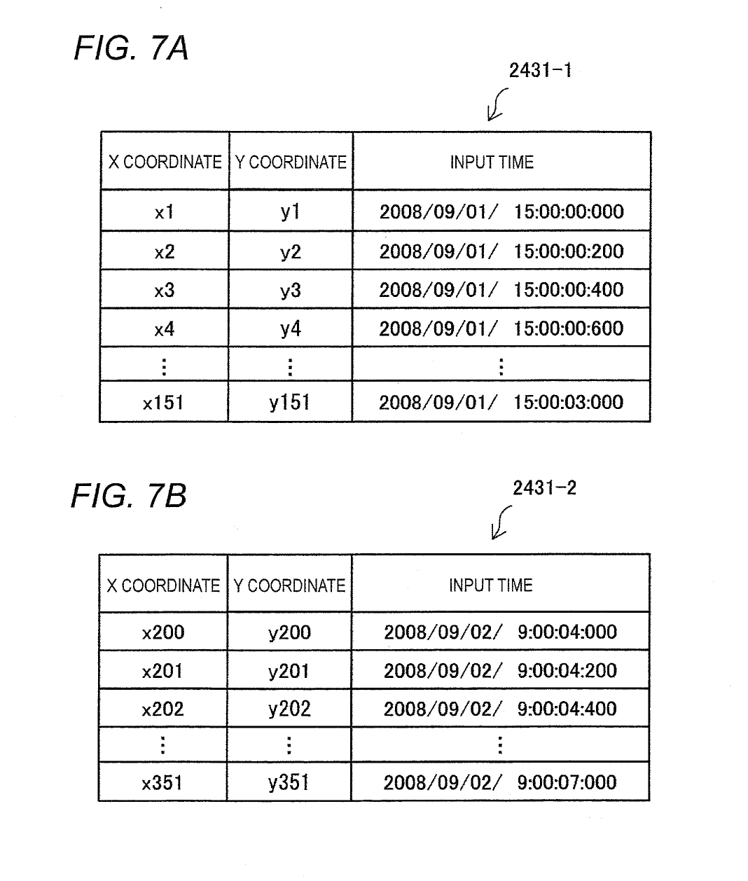

Next, with reference to FIGS. 3 to 5, the configuration of the flash ROM 24 will be described. The flash ROM 24 has a plurality of storage areas that includes an image information storage area 241, a slideshow information storage area 242, a display information storage area 243, and the like. The image information storage area stores an image information database 2411 as shown in FIG. 4, which includes image information on pictures or the like acquired from other devices. The slideshow information storage area 242 stores a slideshow information database 2421 as shown in FIG. 5, which includes information on a slideshow of displaying a plurality of image information by intermittently switching them at certain time intervals. The display information storage area 243 stores display information databases 2431-1 and 2431-2 as shown in FIGS. 7A and 7B.

Herein, with reference to FIG. 4, the image information database 2411 will be described. In the image information database 2411, the items of image ID, image information, input information, input person information, number of input characters, and input time of input information are stored while being associated with one another. In the item of image ID, information for identifying image information is stored in the form of numerical information. The image ID is set to be automatically numbered when the display terminal device 10 acquires the image information. In the item of image information, the file name of the image information is stored. The image information is stored, such that information, for example, on file formats, such as Joint Photographic Experts Group (JPEG), Portable Network Graphics (PNG), and Graphics Interchange Format (GIF), corresponds to each file name. In the item of input information, identification information on information which the user has input by operating the display terminal device 10 is stored in the form of symbols. Although a detailed description of input information will be given later, manual input information input via the touch panel 27 of the display terminal device 10 or text data, i.e., information on characters input using a keyboard (not shown) or the like which can be connected to the display terminal device 10 is stored. In the item of input person information, identification information on input persons, each of whom has input input information, is stored. In the item of number of input characters, if input information is text data as described above, information on the number of the characters which have been input is stored by detecting the number of the characters, which have been input, by analyzing the text data. In the item of input time of input information, information on a time when the input information was started to be input by the user is stored.

Specifically, for example, if the image ID is 001, image information AAA is associated but any of the items of input information, input person information, and number of input characters is not stored. In 002 of the image ID, input person information K, L, M, and N is stored, associated with image information BBB and input information B1, B2, B3, and B4. In this illustrative embodiment, since B3 and B4 of the input information are text data, numerical values 7 and 10 are stored as information on the number of input characters while associated with each other. In addition, the input times 2008/09/01/15:00, 2008/09/02/9:00, 2008/09/03/15:00, 2008/09/04/10:00 are stored, while associated with input information B1, B2, B3, and B4, respectively.

Next, with reference to FIG. 5, the slideshow information database 2421 will be described. In the slideshow information database 2421, slideshow ID items and image ID items are stored while associated with each other. In the slideshow ID, identification information for identifying information on a slideshow is stored in the form of symbols. The slideshow ID is set to be automatically numbered when a user makes out the slideshow by selecting a plurality of image information. In the item of image ID, an image ID of image information is stored as information to be displayed as the slideshow, selected from a plurality of image information stored in the image information database 2411. For example, when the slideshow ID is L1, image ID 001, 002, 003, 004 is stored while associated with L1. Therefore, when the user selects L1 of the slideshow ID by operating the display terminal device 10, image information and display information associated with 001, 002, 003, and 004 of the image ID can be displayed on the display unit 12 by a slideshow.

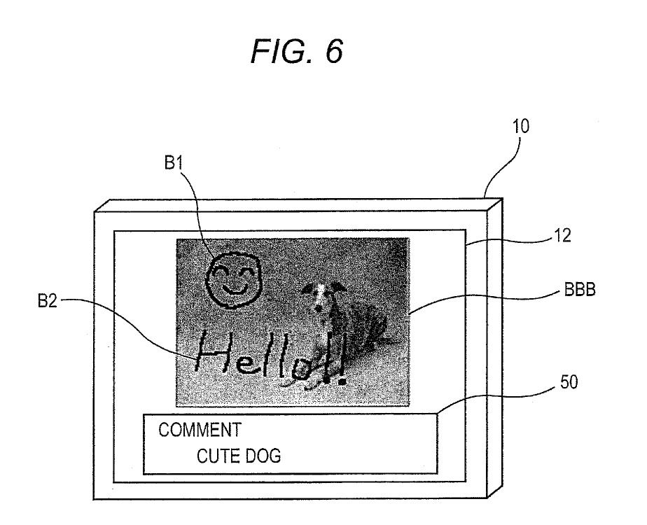

With reference to FIGS. 6 to 7B, input information of the display information associated in the image information database 2411 will be described in detail. FIG. 6 is an explanatory diagram of a display screen of the display unit 12 of the display terminal device 10, in which image information BBB corresponding to image ID 002 of the image information database 2411 and display information corresponding thereto are display at the same time. As shown in FIG. 6, both input information B1 and input information B2 are information that the user has input for the image information as a symbol, a picture and characters, such as a comment, by the user's hand using the touch panel. As shown in FIGS. 7A and 7B, the input information B1 and B2 are respectively stored in the display information storage area 243 as the display information databases 2431-1 (FIG. 7A) and 2431-2 (FIG. 7B) including coordinate information for display on the display unit 12. A character information display area 50 displayed in the lower portion of the display unit 12 is an area in which text data corresponding to input information B3 and B4 stored in the image information database 2411 are displayed as character information. For example, in this illustrative embodiment, the text data of input information B3 is set to include information of a comment “CUTE DOG,” including 7 input characters, and the text data of input information B4 is set to include information of a comment “HAVE A WALK NEXT TIME,” including 17 input characters.

Here, with reference to FIGS. 7A and 7B, the display information databases 2431-1 and 2431-2 will be described in detail. In the display information databases 2431-1 and 2431-2, items of X coordinate, Y coordinate, and input time are stored while associated with one another. In the items of X coordinate and Y coordinate, information representing a relative display position of input information input to the touch panel 27 is stored in the form of numerical values at every certain time interval (e.g., 200 ms interval), using a certain reference position in a display area of corresponding image information, for example, the center position or the position of an upper left corner as reference coordinates (0, 0). In the item of input time, time information acquired from the time-measuring unit 28 provided in the display terminal device 10 is stored in the form of year/month/day/hour:minute:second:ms, corresponding to X and Y coordinate information. For example, as shown in FIG. 7, the input information B1, input by the user, indicates that the time of a touch input in a position, having an X coordinate of x1 and a Y coordinate of y1, is 2008/09/01/15:00:00:000. In this illustrative embodiment, the input information B1 indicates that a touch input is made in a position, having an X coordinate of x2 and a Y coordinate of y2, at a time 2008/09/01/15:00:00:200 after a certain time interval of 200 ms. After that, at every time interval of 200 ms, coordinate information, which the user has input on the touch panel by the user's hand, is stored in the display information database 2431-1. That is, the display information database 2431-1 shown in FIG. 7 indicates that input information B1 of this illustrative embodiment is stored in the form of information that includes X coordinates from x1 to x151 and Y coordinates from y1 to y151. In this manner, input information B1 shown in FIG. 6 is drawn by specifying the coordinate information and the times. Similarly, input information B2 indicates that X coordinates are stored as information on x200 to x351 and Y coordinates are stored as information on y200 to y351 in the display information database 2431-2. In addition, in the display information database 2431-1, an input time when input information B1 is input by the user is calculated to be 3 seconds as an input start time of 2008/09/01/15:00:00:000 is subtracted from an input complete time of 2008/09/01/15:00:03:000. Similarly, an input time of input information B2 can be calculated to be 3 seconds as an input start time of 2008/09/02/9:00:04:000 is subtracted from an input complete time of 2008/09/02/09:00:07:000.

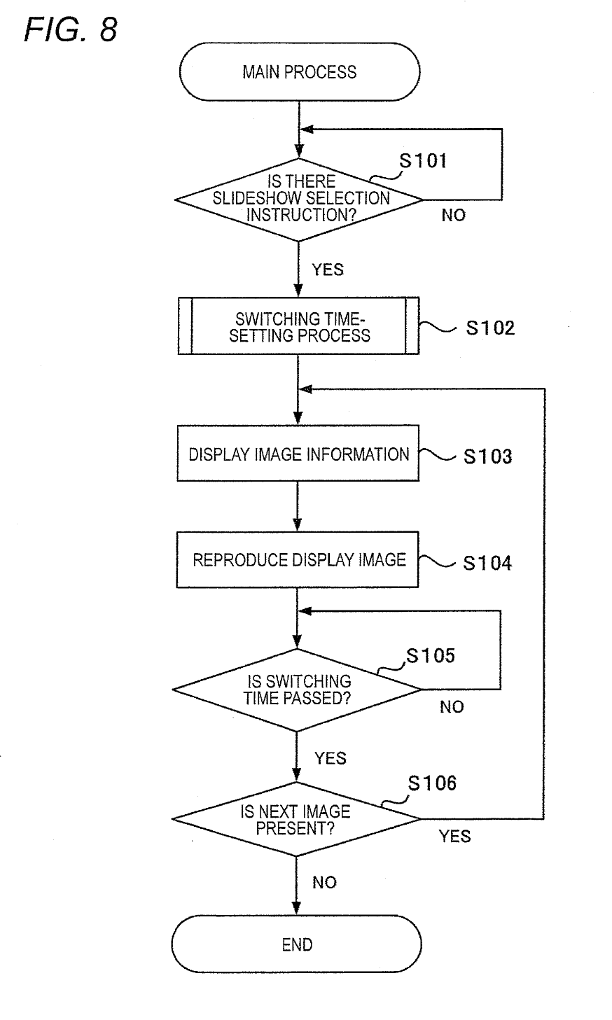

With reference to FIG. 8, a description will be given of a main process executed by the display terminal device 10. The main process shown in FIG. 8 is a process that the CPU 21 executes following the program stored in the ROM 22.

The main process shown in FIG. 8 starts when the power of the display terminal device 10 is turned on. First, the CPU 21 determines whether or not there is a slideshow selection instruction (S101). Here, it is determined whether or not the user has instructed and input an ID of a slideshow, which the user intends to reproduce, from the slideshow database by operating the display terminal device 10. A detailed description of an instruction input method herein is omitted. However, for example, an input method including displaying a selection screen of slideshow IDs on the display unit 12, so that the user inputs an instruction using the touch pen 11 or a finger, or a method of allowing the user to directly input the number of the slideshow ID can be used.

In the process of step S101, if the CPU 21 determines that there is no slideshow selection instruction (S101: NO), the process returns to step S101 and continues to repeat. In the process of step S101, if the CPU 21 determines that there is a selection instruction of a slideshow (S101: YES), a switching time-setting process is executed (S102).

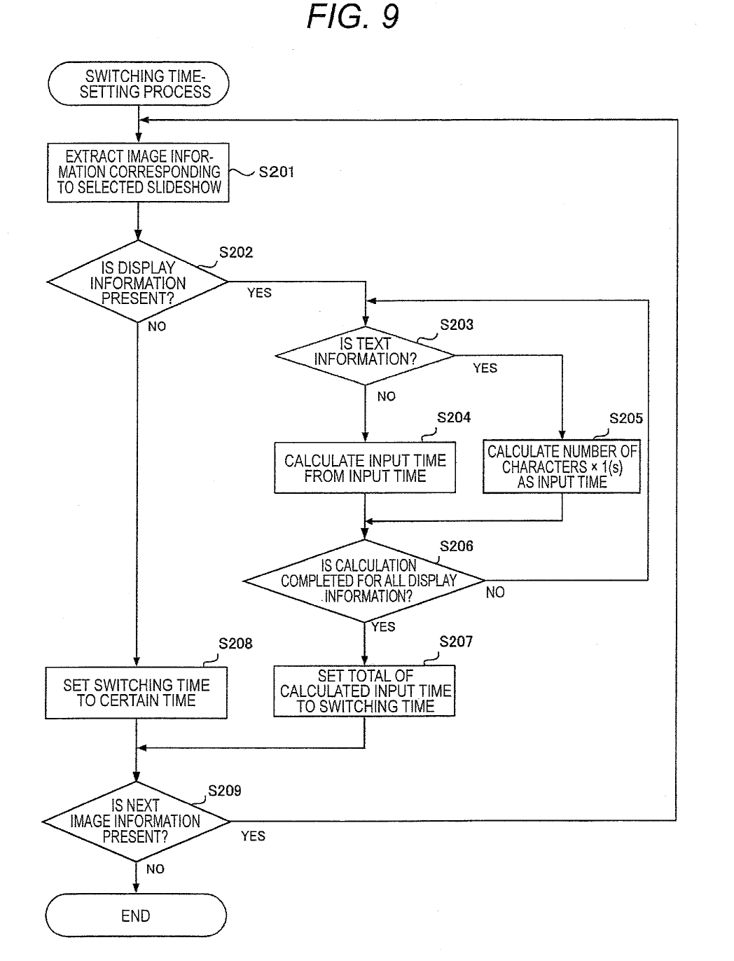

Here, with reference to FIG. 9, the switching time-setting process will be described. FIG. 9 is a flowchart of a switching time-setting process. First, the CPU 21 executes the process of extracting image information, which is associated with the selected slideshow (S201). In detail, in this process, the ID of the slideshow selected in the process of step S101 in FIG. 8 is specified in the slideshow information database 2421, and the image information on the image ID stored in the item of corresponding image ID is extracted from the image information database 2411. For example, in this illustrative embodiment, in the process of step S101, if L1 is selected as slideshow ID by the user, 001, 002, 003, and 004 of image IDs are specified with reference to the slideshow information database 2421, and furthermore, a plurality of information corresponding to image IDs, such as 001, 002, 003, and 004, are extracted with reference to the image information database 2411.

Next, the CPU 21 executes a process of determining whether or not display information corresponding to the image ID extracted in step S201 is stored with reference to the image information database 2411 (S202). If it is determined that there is no corresponding display information as the result of the process 5202 (S202: NO), the CPU 21 executes a process of setting a switching time to a certain time (S208), and executes a process of determining whether or not there is next image information to be extracted (S209).

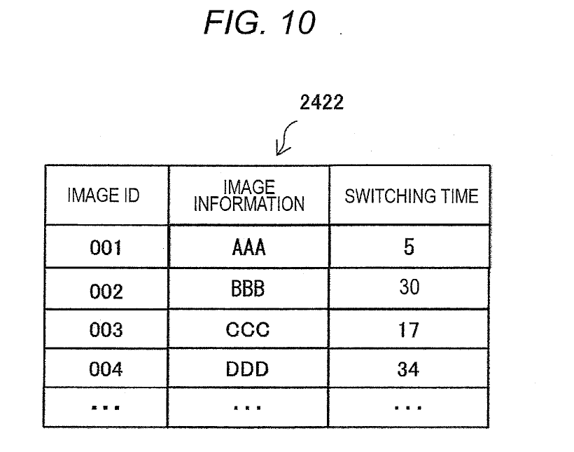

Here, the process of above steps S201, S202, S208, and S209 will be described in detail. In the process of step S201, image ID 001 is extracted first, and the CPU 21 determines that display information corresponding to image ID 001 is not stored with reference to the image information database 2411 (S202: NO). Then, in the process of step S208, the switching time is set to a certain time (for example 5 seconds in this illustrative embodiment), and a switching time information database 2422 shown in FIG. 10 is temporarily composed and stored in the RAM 23. In the switching time information database 2422 shown in FIG. 10, items of image ID, image information, and switching time are stored while associated with each other. Herein, the switching time indicates a time until one image information displayed on the display unit 12 of this illustrative embodiment is switched into another image information. Therefore, in the case of image ID 001, the switching time is stored to be 5 seconds. After the process of step S208, in the process of step S209, it is determined that image ID 002 after image ID 001 is stored (S209: YES), and the process returns to step S201.

Returning to the explanation of the process of step S201 (FIG. 9), if it is determined that the image information extracted in step S201 has display information (S202: YES), it is determined whether or not input information in the display information is text information (S203). In the process of step S203, if the CPU 21 determines that the input information is not text information (S203: NO), an input time is calculated from an input time corresponding to the display information (S204).

Here, the process of steps S201 to S206 will be described in detail with respect to this illustrative embodiment. If image ID 002 after image ID 001 is extracted in the process of step S201, the process of step S202 determines that there is input information B1 corresponding to image ID 002 by referring to the image information database 2411 (FIG. 4) (S202: YES). Then, the process of step S203 determines whether or not input information B1 is text information (S203). Since the CPU 21 determines that input information B1 is not text information (S203: NO), an input time of input information B1 is calculated to be 3 seconds as described above with reference to the display information database 2431-1 corresponding to input information B1, and is temporarily stored in the RAM 23.

Then, in the process of step S206, CPU 21 determines that all display information is not processed yet with reference to the image information database 2411 (S206: NO) since input information B2, B3, and B4 in addition to input information B1 corresponding to image ID 002 is stored, and returns to the process of step S203. In the process of S203, the CPU 21 determines whether or not input information B2 after input information B1 is text information, and determines that input information B2 is not text information similarly to B1 (S203: NO). In addition, with reference to the display information database 2431-2, an input time is calculated to be 3 seconds as described above and is temporarily stored in the RAM 23 (S204). In the process of step S206, it is determined that there is another display information, which is not processed yet (S206: NO), and the process returns to the process of step S203.

Returning to the process of step S203, the CPU 21 determines whether or not input information B3 stored after input information B2 is text information with reference to the image information database 2411. In this illustrative embodiment, since input information B3 is text information, in the process of step S203, the CPU 21 determines that input information B3 is text information (S203: YES), extracts 7, i.e., information on the corresponding number of input characters, from the image information database 2411, calculates an input time to be 7 seconds by conversion from the number of characters×1 second, and temporarily stores the input time in the RAM 23 (S205). Then, also in the process of step S206, it is determined that all of display information is not processed (S206: NO), the process returns to step S203.

Next, in the process of step S203, the CPU 21 determines whether or not input information B4 stored after input information B3 is text information with reference to the image information database 2411. In this illustrative embodiment, since input information B4 is also text information, in the process of steps S203 and S205, the CPU 21 executes the same manner as for input information B3, calculates the input time to be 17 seconds, and temporarily stores in the RAM 23 (S204).

With reference to the image information database 2411, the CPU 21 determines that all of the process for the display information corresponding to image ID 002 is completed (S206: YES), and stores a total of the input times calculated in the process of step S204 and step S205 as a switching time in the switching time information database 2422 (S207). In this illustrative embodiment, as described above, the CPU 21 sums all of 3 seconds (i.e., the input time of input information B1), 3 seconds (i.e., the input time of input information B2), 7 seconds (i.e., the input time of input information B3), and 17 seconds (i.e., the input time of input information B4), and stores the switching time corresponding to image ID 002 as 30 seconds in the switching time information database 2422 (S207).

After the process of step S207, the CPU 21 determines whether or not there is next image information by referring to the slideshow information database 2421 (S209), and determines that there is image ID 003 after image ID 002 (S207: YES). Therefore, the process returns to step S201, and the CPU 21 executes the process from steps S202 to S270 for image ID 003. Then, the CPU 21 executes the above-described process for image ID 004. Therefore, the switching times for image ID 003 and image ID 004 are stored in the switching time information database 2422 such that they are calculated to be 17 seconds and 34 seconds. In the process of step S209 for image ID 004, the CPU 21 determines that there is no next image information (S209: NO), and completes the switching time-setting process.

Returning to the main process in FIG. 8, after the switching time-setting process of step S102 is executed, the CPU 21 executes a process of displaying image information (S103). In the process of step S103, the CPU 21 performs the process of extracting image ID corresponding to the slideshow ID, to which the selection instruction was made in the process of step S101, with reference to the slideshow information database 2421, and displaying the extracted image ID on the display unit 12. Specifically, since L1 has been selected as the slideshow ID in step S101, initial image ID 001 corresponding to L1 of the slideshow ID is specified, and image information AAA is displayed on the display unit 12 with reference to the image information database 2411 (S103).

After step S103, the process of reproducing display information corresponding to the image information that is being displayed is executed (S104). In the process of step S103, image ID 001 is specified in this illustrative embodiment. However, since display information corresponding to image ID 001 is not stored in the image information database 2411, no display information is displayed to be reproduced in step S104. Then, the CPU 21 determines whether or not the switching time is passed (S105).

Describing step S105 in detail, after the display of image information AAA corresponding to image ID 001 in the process of step S103, the timer of the time-measuring unit 28 is started, a switching time of 5 seconds corresponding to image ID 001 is acquired from the switching time information database 2422, and it is determined whether or not 5 seconds are passed in the timer (S105). If the CPU 21 determines that the switching time is not passed, the process is repeated until the switching time is passed (S105: NO). In the process of step S105, if the CPU 21 determines that the switching time of image ID 001 is passed (S105: YES), it determines whether or not there is next image information to be displayed on the display unit 12. If the CPU 21 determines that there is next image information to be displayed (S106: YES), it returns to the process of step S103, switches the display to next image information to be displayed, and executes the following process of S104 to S106 in the same manner. Otherwise, if the CPU 21 determines that there is no next image information to be displayed in the process of step S106 (S106: NO), the main process is completed.

In the process of step S106 for image ID 001, which is described above, the CPU 21 determines that there is image ID 002 to be displayed after image ID 001 (S106: YES), image information BBB corresponding to image ID 002 is displayed on the display unit 12 (S103).

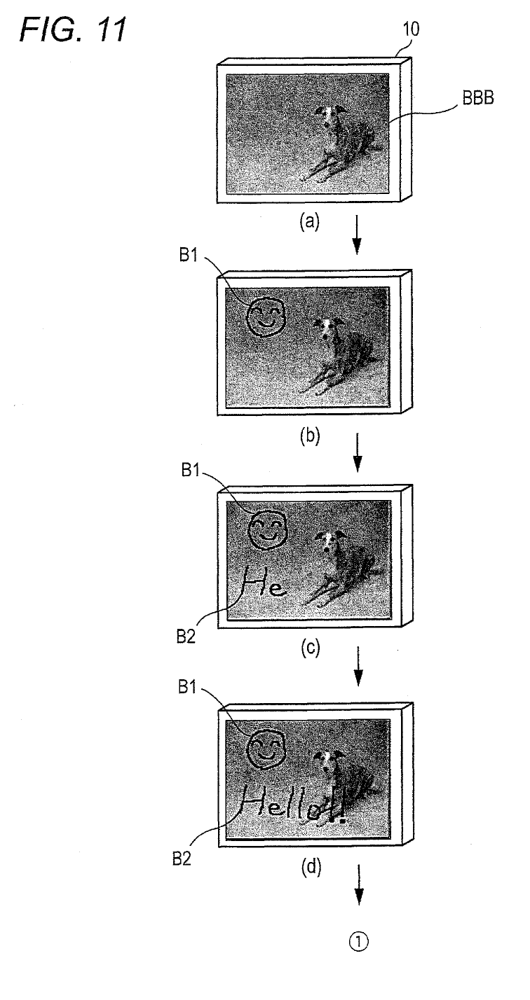

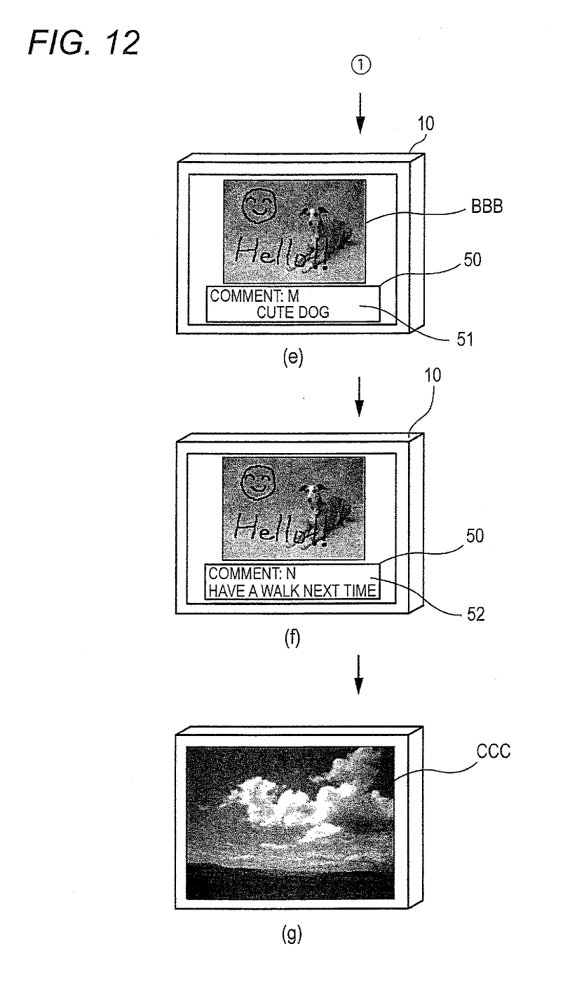

Here, the process of steps S103 to S106 for image ID 002 will be described in detail with reference to explanatory diagrams of the display screen in FIGS. 11 and 12. First, the display screen state in (a) of FIG. 11 indicates a state, in the process of step S103, after image information AAA corresponding to image ID 001 of an image, which is not shown, is switched to image information BBB corresponding to image ID 002. Then, in the process of step S104, since input information B1, i.e., display information is associated with the image information BBB, which is being displayed, with reference to the image information database 2411, the process of reproducing and displaying input information B1 to overlap the image information BBB, which is being displayed, as shown in (b) of FIG. 11 based on corresponding coordinate information on the display information database 2431-1 is executed. (b) of FIG. 11 indicates the sate after input information B1 is reproduced and displayed. It is noted that the reproduction display described herein indicates a process of adding displays in the sequence, by which input information is input, to display positions corresponding to coordinate information stored in the display information database 2411-1 at certain time intervals (i.e., 200 ms intervals in this illustrative embodiment). Therefore, while image information BBB is being displayed, the user can observe the way how input information B1 is input for 3 seconds by the above-described reproduction display.

In the process of step S104, after the reproducing and displaying of input information B1, the CPU 21 executes a process of performing plying and displaying for 3 seconds by starting the reproduction display of input information based on the display information database 2431-2 corresponding to input information B2. Therefore, as shown on the display screen in (c) and (d) of FIG. 11, input information B2 is reproduced and displayed as display information to overlap the display of image information BBB.

Further, in the process of step S104, then the CPU 21 executes a process of reproducing and displaying input information B3 of display information associated with image ID 002, as character information by extracting it with reference to the image information database 2411. As shown in (e) of FIG. 12, input information B1 and B2, which is also shown in FIG. 11, is displayed to overlap image information BBB of the display screen, and in addition, character information 51 corresponding to input information B3 is newly added to the lower portion of the screen. Reproduction display of character information, which is described above, indicates a process of sequentially displaying input characters by adding and displaying one character in 1 second. Therefore, in this illustrative embodiment, since the number of input characters is stored to be 7 in input information B3 with reference to the image information database 2411, display information on input information B3 is reproduced and displayed for 7 seconds by displaying characters one by one. Therefore, (e) of FIG. 12 indicates a display screen state when the reproduction display of input information B3 is completed. It is noted that, as shown in (e) of FIG. 12, a description of input person information M, which is information on an input person of input information B3, can be displayed in the character information display area 50. Then, it is possible to allow the user to know who input character information as input information.

Then, in the process of step S104, after input information B3 of the character information display area 50 is reproduced and displayed, reproduction display is performed for input information B4 in the same manner as for input information B3, with reference to the image information database 2411. In addition, in input information B4, since the number of input characters is set to be 17, reproduction display time is 17 seconds, and characters are reproduced and displayed one by one within this time period. (f) of FIG. 12 shows a display screen state when the reproduction display of input information B4 as display information is completed. In this illustrative embodiment, if there is a number of character information as input information like image ID 002, when reproducing and displaying of one character information is completed, the display in the character information display area 50 is canceled first, and reproduction display of next character information to be reproduced is started.

In the process of step S105 in the main process in FIG. 8, after display of image information BBB is started, it is determined whether or not a switching time of 30 seconds corresponding to image ID 002, stored in the switching time information database 2422, is passed. If it is determined that 30 seconds are passed in the process of step S105 (S105: YES), the CPU 21 determines that there is image ID 003 to be displayed next (S106: YES), returns to the process of step S103, and starts displaying image information CCC corresponding to image ID 003. (g) of FIG. 12 shows a display screen state after display is switched to image information CCC. After (g) of FIG. 12, the explanatory diagrams of the display screen are omitted. However, steps S103 to S106 described above are respectively and sequentially executed for image ID 003 and image ID 004. In the process of step S106 for image ID 004, the CPU 21 determines that there is no next image information to be displayed (S106: NO), and the main process is completed.

Therefore, in the case where display information which is a plurality of input information added to image information is reproduced on the same display screen as image information, which is being displayed, display can be switched at a switching time suitable for input conditions of a plurality of display information. Therefore, the user can observe a plurality of image information and a plurality of display information under optimum conditions.

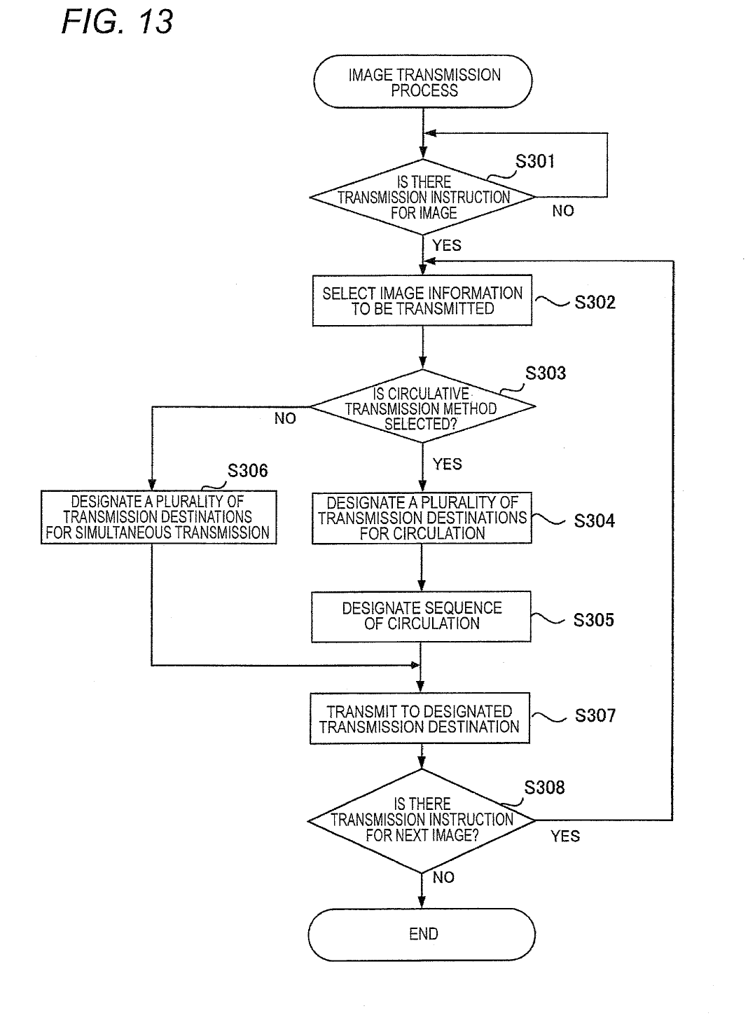

Meanwhile, the configuration and the process described in the above illustrative embodiment are explanatory and various alterations are conceivable. Next, a first modified illustrative embodiment of the above illustrative embodiment will be described with reference to FIG. 13 to 15. In the first modified illustrative embodiment, the schematic and electrical configurations of the display terminal device 10 are the same as those of the display terminal device 10 of the above-described illustrative embodiment and thus a description thereof will be omitted.

In the first modified illustrative embodiment, when transmitting image information to at least one display terminal device 10 at another point, the display terminal device 10 can transmit image information by designating a transmission method of transmitting image information to be circulated through a plurality of display terminal devices 10 or a transmission method of simultaneously transmitting image information to a plurality of display terminal devices 10. In the following, there will be described a main process 2 that is executed by the display terminal device 10 at its own point when image information transmitted by the designated transmission method is received from the display terminal device 10 at another point.

With reference to FIG. 13, the image transmission process executed by the display terminal device 10 of the first modified illustrative embodiment will be described. FIG. 13 is a flowchart of the image transmission process. First, the CPU 21 determines whether or not there is a transmission instruction for image information (S301). If it is determined that there is no transmission instruction in the process of step S301 (S301: NO), the process returns to step S301 and is executed repeatedly. It is noted that the transmission instruction of image information described herein refers to an instruction that the user makes by operating the display terminal device 10 to transmit stored image information to the display terminal device 10 at another point. For example, for such determination, a method can be employed, which includes displaying an icon (not shown) corresponding to the transmission instruction of image information on the display screen of the display unit 12 and determining whether or not the transmission destination instruction is input based upon touching of the icon via the touch panel 27 by the user.

In the process of step S301, if the CPU 21 determines that there is a transmission instruction of image information (S301: YES), executes a process of selecting image information to be transmitted (S302). For example, reduced images of a plurality of stored image information can be displayed in a thumbnail manner or file names of image information can be displayed in the form of a list on the display unit 12, so that the user can select one image information, which is input for an instruction via the touch panel 27, by touching one image information that the user wants to transmit while watching the display screen.

Then, the CPU 21 determines whether or not a circulative transmission method is instructed (S303). Herein, the CPU 21 determines whether it is instructed to transmit image information selected in the process of step S302 to a plurality of other display terminal devices in a circulative transmission method or to simultaneously transmit a plurality of other display terminal devices (S303). In the process of step S303, if the CPU 21 determines that the circulative transmission method is instructed (S303), it executes a process of designating a plurality of transmission destinations for circulation (S304). Specifically, transmission destination information of other display terminal devices, such as the telephone numbers or network addresses, stored in the display terminal device 10 is displayed on the display unit 12, so that the user can set transmission destination information on a transmission destination, to which the user wants to transmit, by selecting it.

Then, the CPU 21 executes a process of designating the sequence of circulative transmission in transmission destination information set in the process of step S304 (S305). Specifically, the CPU 21 executes the process of displaying a display screen, which displays an instruction allowing selection of a transmission sequence from transmission destination information set in the process of step S304, on the display unit 2 and receiving information on the sequence of circulative transmission by the user.

Then, the CPU 21 executes a process of transmitting image information selected in step S302 to first transmission destination in the sequence of circulative transmission designated in the process of step S305 (S307). It is noted that in the step S307, transmission method information is also transmitted, which includes information on the circulation sequence of transmission destination information to be circulated set in the process of step S304, while associating the transmission method information with image information. Therefore, when one of other display terminal devices 10 receives image information transmitted in the process of step S307, it can confirm transmission destination information of next one of other display terminals 10, to which circulative transmission is designated, in addition to received image information.

If it is determined in the process of step S303 that the method of simultaneously transmitting a plurality of other display units 10 is instructed instead of the circulative transmission method (S303: NO), a process of setting a plurality of transmission destination information for simultaneous transmission is executed (S306). Specifically, transmission destination information of other display terminal devices 10, such as telephone numbers or network addresses, stored in the display terminal device 10 is displayed on the display unit 12, so that the user can set the transmission destination information on a transmission destination, to which the user wants to transmit, by selecting it.

After the process of step S306, the CPU 21 executes a process of associating image information, selected in step S302, with transmission method information indicating the transmission method, instructed in step S303, and simultaneously transmitting it according to transmission destination information on other display terminal devices designated in step S306 (S307). After the process of step S307, the CPU 21 then determines whether or not there is an instruction to transmit image information (S308). If it is determined that there is an instruction to transmit image information in the process of step S308 (S308: YES), the process returns to step S302 and the same process is executed repeatedly. If it is determined that there is no instruction to transmit image information in the process of step S308 (S308: NO), the image transmission process as the main process is completed.

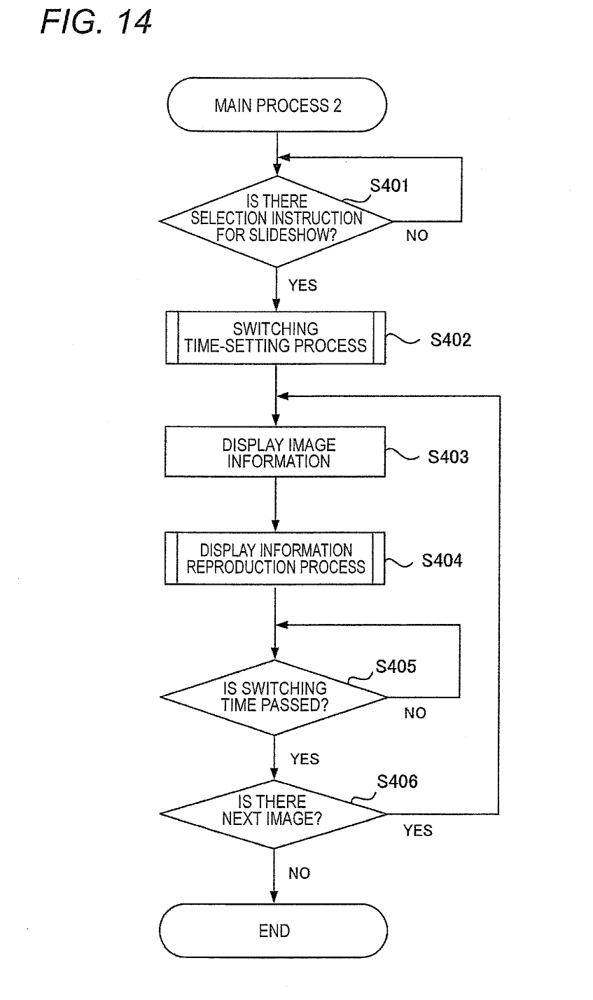

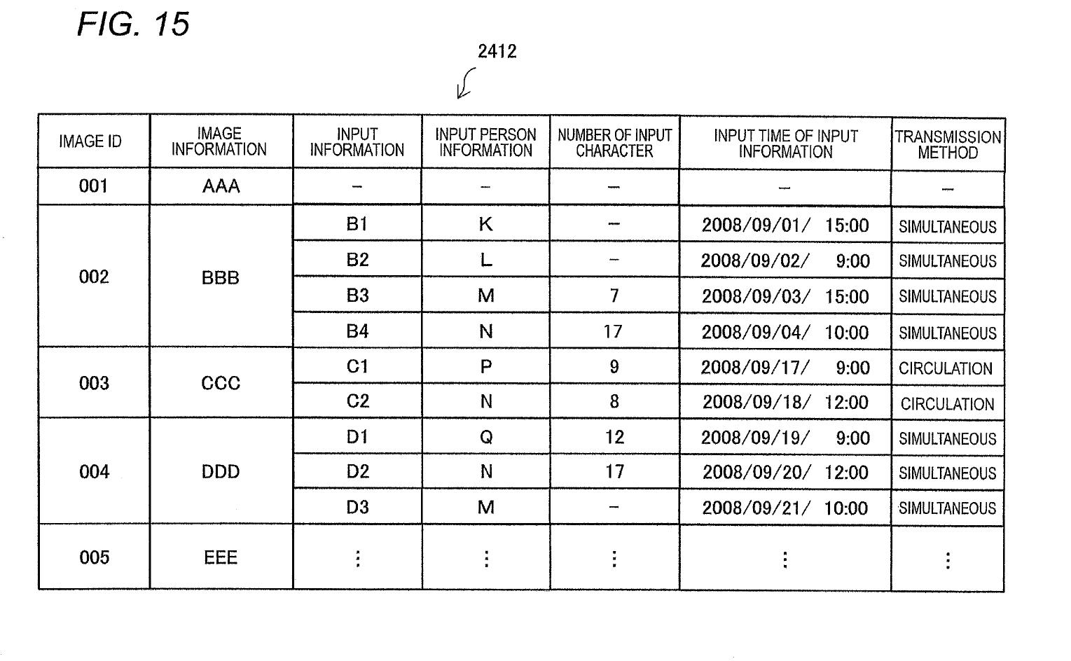

Next, with reference to FIGS. 14 and 15, main process 2 executed by the display terminal device 10 in the first modified illustrative embodiment will be described. The main process 2 is set to execute a process for transmitted image information, to which the transmission method is designated by the above-described image transmission process.

FIG. 14 is a flowchart of the main process 2 executed by the display terminal device in the first modified illustrative embodiment. In addition, the main process 2 is the same as the main process illustrated in FIG. 8, except for only several steps, and thus a description of the steps of the same process will be omitted.

First, the CPU 21 determines whether or not there is a slide show selection instruction (S401). Herein, since the same process as the main process in FIG. 8 is executed, a detailed description is omitted. However, specifically, also in the first modified illustrative embodiment, the process of specifying the ID of a slideshow, selected in the process of step S401 from among the slideshow information database 2421, and extracting image information on image ID, stored in the item of corresponding image ID, from the image information database 2412 shown in FIG. 15, is executed.

Here, with reference to FIG. 15, the image information database 2412 in the first modified illustrative embodiment will be described. The image information database 2412 shown in FIG. 15 is the same as the image information database 2411 (FIG. 4) of the above-described illustrative embodiment, except that each item of the transmission method matches with each image ID. In the item of the transmission method, information, which presents how transmission was made when the display terminal device 10 transmits an image to other display terminal devices 10, is stored according to the above-described image transmission process (FIG. 13). For example, as for image ID 001, nothing is stored in the item of transmission method, indicating that it is not transmitted by the above-described image transmission process. As for image ID 002 and image ID 004, information labeled as “simultaneousness” is stored in the item of transmission method, indicating that it is image information transmitted by the simultaneous transmission method in the above-described image transmission process. In addition, as for image ID 003, information labeled as “circulation” is stored in the item of corresponding transmission method, indicating that it is image information that is transmitted, to which the circulative transmission method is designated by the above-described image transmission process.

Returning to main process 2 in FIG. 14, since the slideshow ID, which is selected in step S401, is L1, the same process is executed from the switching time-setting process in step S402 to the process of displaying image information in step S403 and from the main process illustrated in FIG. 8 to the process of step S103. In the process of step S403, with reference to the image information database 2412, image information AAA corresponding to initial image ID 001, in which the slideshow ID is specified as L1, is displayed. With reference to the image information database 2412, since display information corresponding to image ID 001 is not stored, the same process as the main process shown in FIG. 8 is executed from step S404 to step S406. Returning to the process of step S403 again, the process of switching the display from image information AAA to image information BBB corresponding to BBB, which is supposed to be displayed next, is executed.

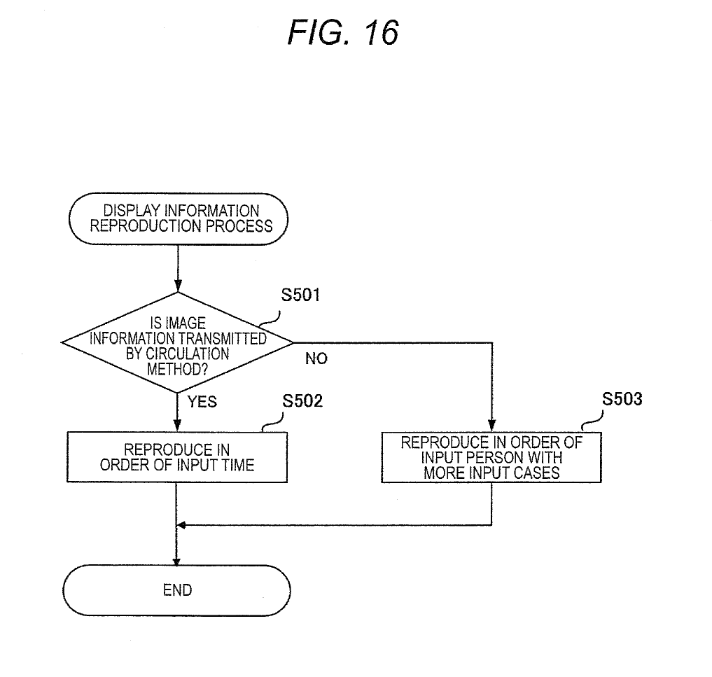

In addition, after image information BBB corresponding to image ID 002 is displayed by the process of step S403, the CPU 21 executes a process of reproducing display information (S404). Here, the process of reproducing display information executed in step S404 is different from step S104 in the main process shown in FIG. 8, and thus will be described in detail with reference to FIG. 16.

FIG. 16 is a flowchart of the process of reproducing display information executed in the above-described process of step S404. First, it is determined whether or not image information, displayed in step S403 of FIG. 4, is image information transmitted by the circulative transmission method (S501). Specifically, information on the transmission method corresponding to image information displayed in the process of step S403 (FIG. 8) is determined with reference to the image information database 2412. In this first modified illustrative embodiment, as for image ID 002 corresponding to image information BBB, which is displayed in the process of step S403, the CPU 21 determines that information labeled as “simultaneousness” is stored in the item of transmission method (S501: NO).

Next, the CPU 21 executes a process of reproducing corresponding display information in order of display information corresponding to input person information having more cases stored in the image information database 2412, among display information corresponding to image ID determined in the process of step S501 (S503). Here, step S503 will be described in detail. First, input information which is display information associated with image ID 002 determined in the process of step S501 is specified to be B1, B2, B3, and B4. Then, input person information corresponding to input information is specified such that input person information K corresponds to input information B1, input person information L corresponds to B2, input person information M corresponds to B3, and input person information N corresponds to B4. As for specified input person information, the number of cases stored in the image information database 2412 is calculated and specified input person information is ranked by the number of calculated cases. For example, in this first modified illustrative embodiment, with reference to the image information database 2412, if input person information corresponding to input information on image ID 002 is examined in order of more cases, it is possible to specify input person information such that input person information N indicates 3 cases and is the greatest, input person information M indicates 2 cases, and K and L indicate 1 case. Therefore, in the process of step S503, the CPU 21 executes a process of displaying input information serving as display information corresponding to image ID 002 in order of the number of input cases of above-described input person information. Thus, input information B4 corresponding to input person information N is first reproduced, input information B3 corresponding to input information M is then reproduced, and input information B1 and B2 corresponding to input person information K and L is reproduced. In the above description, input information B1 and input information B2, having the same number of input cases of input person information, are set to be reproduced in order of earlier input time. However, the present invention is not specifically limited thereto.

If it is determined that image information displayed in step S403 of FIG. 14 is image information transmitted by the circulative method in the process of step S501 (S501: YES), display information corresponding to determined image information is reproduced in order of earlier input time (S502). Specifically, in the case where image information corresponding to image ID 003 is displayed, for example, in the process of step S403, it is first determined that information labeled as “circulation” is stored in the item of corresponding transmission method with reference to the image information database 2412 (S501: YES). As for input information C1 and C2 of display information corresponding to image ID 003, a process of reproducing input information in order of C1 and C2, i.e., in order of input time from past to present on the display unit 12 is executed (S502). After the process of step S502 or step S503 is executed, the process of reproducing display information as the main process is completed.

As described above, in the case where image information is transmitted simultaneously to a plurality of other display terminal devices 10 designated as a transmission destination, the display terminal device 10 of its own terminal can reproduce display information added to image information received from other display terminal devices 10 designated as a transmission destination, in order of display information corresponding to the order of input persons who provided more display information in the past. Therefore, the user can sequentially display and observe image information in order of the familiarity of image information of other users, i.e., in order of the number of transmission/reception of image information or display information. In addition, when image information is transmitted such that it is circulated through a plurality of other display terminals 10, the display terminal device 10 of its own terminal can reproduce display information added to image information, which is received from other display terminal devices 10 after being circulated, in order of the input time from past to present, i.e., in order of the input caused by the circulation. Therefore, the user can observe display information added to image information, which is circulated as above, in order of the circulation.

Returning to main process 2 in FIG. 2, after the process of reproducing display information in step S404 is executed, the CPU 21 executes the process of step S405 and step S406. The process of steps S405 and S406 in this first modified illustrative embodiment are the same as that of steps S105 and S106 in the above-described main process of FIG. 8, and thus a detailed description will be omitted.

Accordingly, when the display terminal device 10 of this first modified illustrative embodiment transmits image information to a display terminal device 10 at another point, it can designate a transmission method so that image information is transmitted to be circulated through a plurality of other display terminal devices 10 or simultaneously transmitted to a plurality of other display terminal devices 10. When image information, transmitted by the designated transmission method, is receive from the display terminal device 10 at another point, the display terminal device 10 at its own point can reproduce display information under reproduction conditions suitable for transmission of image information by executing main process 2.

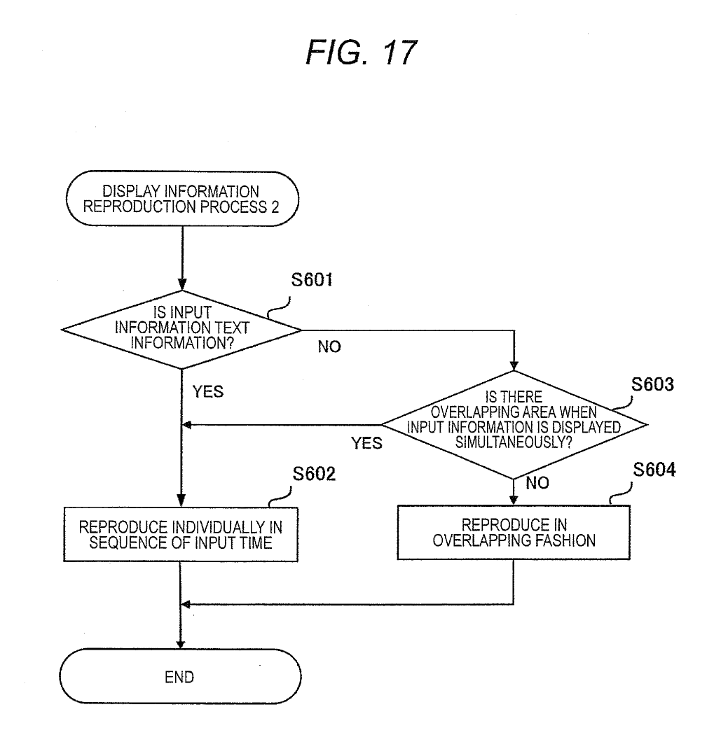

In addition, various modifications other than the above-described first modified illustrative embodiment can be made. In the process of step S104 in the main process of FIG. 8, among input information as a plurality of display information, input information input through the touch panel is reproduced to be written over image information. However, this is not intended to be limiting, but other methods can be used. For example, a method may include a process of determining whether or not a plurality of display information is input information, which is input by the user through the touch panel, or text information, a process of determining whether or not there is an overlapping area of input information when all input information, which is determined to be input information input through the touch panel, is displayed simultaneously on the display screen, and a process of, if it is determined that there is no overlapping area of input information, reproducing a plurality of input information so that it is overwritten. If it is determined that there is an overlapping area of input information, it is possible to cancel one input information after it is reproduced and process the next input information as if newly reproducing it. This is because, if a plurality of input information is reproduced to be overwritten on the same image information, overlapping input information making it difficult to identify the information. Herein, as described above, a second modified illustrative embodiment of step 104 will be described with reference to FIG. 17.

FIG. 17 is a flowchart of the process of reproducing display information executed by the display terminal device 10, according to the second modified illustrative embodiment of step S104 of the main process (FIG. 8). First, the CPU 21 determines whether or not input information serving as display information is text information or not (S601). Specifically, it is determined whether or not input information on display information corresponding to image information, which is displayed in the process of step S103 in FIG. 8, is text information. If it is determined not to be text information (S601: NO), it is determined whether or not there is an overlapping area when all input information, which is determined not to be text information, is simultaneously displayed (S603). Specifically, for example, if displayed image information is BBB, it is determined that input information B1 and B2 of display information is not text information by referring to the image information database 2411 as display information, corresponding image ID of which is 002 (S603: NO). Then, it is determined whether or not there is an overlapping area of input information on the display screen of the display unit 12 when both input information B1 and B2 is displayed (S603). Specifically, it is possible to determine whether or not same coordinate information is stored by referring to coordinate information on the display information databases 2431-1 and 2431-2 corresponding to input information B1 and B2. In this illustrative embodiment, even with reference to FIG. 6, there is no overlapping area even if input information B1 and B2 is simultaneously displayed. Therefore, it is determined that there is no overlapping area in the process of step S603 (S603: NO), and the CPU 21 executes the process of sequentially reproducing input information serving as display information, determined in the process of step S603, on the display unit 12 as if overwriting it (S604).

In addition, in the process of step S603, if it is determined that there is an overlapping area when input information on display information is simultaneously displayed (S603: YES), input information is individually reproduced in order of input time corresponding to input information so that the order of input time is from past to present. In addition, in the process of step S601, also in the case where input information is determined to be text information (S601: YES), the process of step S602 is executed in the same manner as described above. In this manner, it is possible to prevent a plurality of display information, input through the touch panel, from overlapping on the display panel, which would otherwise become difficult to identify. Therefore, the user can appreciate image information and a plurality of display information under more appropriate reproduction conditions.

In addition, as another modified illustrative embodiment, for example, in the process of step S205 of the switching time-setting process in FIG. 9, if input information on display information is text information, input time is calculated by conversion of the number of characters×1 second. However, this is not intended to be limiting. The user may be allowed to appropriately adjust reproduction time to be, for example, 1 character×0.5 second or 1 character×2 seconds.

In the above-described illustrative embodiment, the image information to be displayed on the display unit 12 is a still image. However, the present invention is not limited thereto. For example, the image information may be a moving image.

What is claimed is:

1. A display terminal device comprising:
a display unit including a display area for displaying image information;
a display control unit configured to control the display unit to display a plurality of image information by switching the image information;
an image information acquiring unit configured to acquire display information to be displayed while being added to the image information and acquire the image information which is associated with a plurality of display information; and
a display condition control unit configured to control a reproduction display condition, under which while image information is displayed on the display unit, a plurality of display information associated with the image information are consecutively reproduced and displayed, and control a switching condition, under which one of the image information is switched into another of the image information, based on the plurality of display information acquired by the image information acquiring unit.

2. The display terminal device according to claim 1,
wherein the display information includes at least input information which is input, input person information indicating a person who input the input information, and time information indicating a time when the input information is input,
the display terminal device further comprising:
an image information storage unit configured to store the input information, the input person information, and the time information while being associated with the image information acquired by the image information acquiring unit, for each of the display information.

3. The display terminal device according to claim 2,
wherein the display condition control unit is configured to count the number of the input person information stored in the image information storage unit for a plurality of image information, and is configured to set the reproduction display condition such that the plurality of display information are reproduced and displayed in order from the display information corresponding to the greater number of the input person information.

4. The display terminal device according to claim 2,
wherein the display condition control unit is configured to set the reproduction display condition such that the plurality of display information are reproduced and displayed in order while the time information of the display information stored in the image information storage unit becomes in order from past to present.

5. The display terminal device according to claim 2, further comprising:
a display area determining unit configured to determine whether there is an overlapping area of input information when a plurality of input information associated with one of the image information stored in the image information storage unit are displayed simultaneously on the display unit,
wherein the display condition control unit is configured to reproduce and display the plurality of input information associated with the image information such that the plurality of input information are overwritten if the display area determining unit determines that the plurality of input information does not overlap with each other.

6. The display terminal device according to claim 2, further comprising:
a transmission method designating unit configured to designate a transmission method for transmitting the image information to another display terminal device via a communication line; and
a communication unit configured to transmit the image information to another display terminal device by the transmission method while associating transmission method information indicating the transmission method designated by the transmission method designating unit with the image information,
wherein if the image information acquiring unit acquires image information transmitted by a communication unit of another display terminal device and if transmission method information is associated with the image information, the display condition control unit controls the reproduction display condition for the plurality of display information associated with the image information based on the transmission method information.

7. The display terminal device according to claim 6,
wherein the transmission method information indicates either one of a simultaneous transmission method of simultaneously transmitting the image information to a plurality of other display terminal devices or a circulative transmission method of transmitting the image information to circulate in order among a plurality of other display terminal devices, and
wherein if the transmission method information for the image information acquired from another display terminal device by the image information acquiring unit indicates the circulative transmission method, the display condition control unit sets the reproduction display condition such that the plurality of display information are reproduced and displayed in order while the time information of the display information associated with the image information becomes in order from past to present.

8. The display terminal device according to claim 2,
wherein the display condition control unit is configured to determine whether the input information of the display information is text information, and is configured to control a time of reproducing and displaying the input information based on the number of characters of the text information if the input information is determined to be text information.

9. A method for controlling a display terminal device including a display area for displaying image information and a display control unit configured to control the display unit to display a plurality of image information by switching the image information, the method comprising:
acquiring display information to be displayed while being added to the image information and acquiring the image information which is associated with a plurality of display information; and
based on the acquired plurality of display information, controlling a reproduction display condition, under which while image information is displayed on the display unit, a plurality of display information associated with the image information are consecutively reproduced and displayed, and controlling a switching condition, under which one of the image information is switched into another of the image information.

10. A storage medium having a computer program stored thereon and readable by a computer for a display terminal device including a display area for displaying image information and a display control unit configured to control the display unit to display a plurality of image information by switching the image information, the computer program, when executed by the computer, causing the computer to perform operations comprising:
acquiring display information to be displayed while being added to the image information and acquiring the image information which is associated with a plurality of display information; and
based on the acquired plurality of display information, controlling a reproduction display condition, under which while image information is displayed on the display unit, a plurality of display information associated with the image information are consecutively reproduced and displayed, and controlling a switching condition, under which one of the image information is switched into another of the image information.
